(19) United States
(12) Patent Application Publication
(10) Pub. No.: US 2023/0223184 A1
(43) Pub. Date: Jul. 13, 2023

(54) Magnetic Device and the Method to Make the Same

(71) Applicant: CYNTEC CO., LTD., Hsinchu (TW)

(72) Inventors: SEN-HUEI CHEN, Yunlin County (TW); YuLun Chang, Miaoli County (TW)

(21) Appl. No.: 18/094,982

(22) Filed: Jan. 9, 2023

Related U.S. Application Data
(60) Provisional application No. 63/297,805, filed on Jan. 10, 2022.

(51) Int. Cl. H01F 27/29; H01F 27/28; H01F 27/24; H01F 41/06

(52) U.S. Cl. CPC H01F 27/29; H01F 27/2823; H01F 27/24; H01F 41/06

(57) ABSTRACT

A magnetic device, a body; and an insulated conductive wire which comprises a metal wire and an insulating layer encapsulating the metal wire, wherein the insulated conductive wire comprises a coil and a first terminal part, wherein an outer surface of the internal metal part of a first portion of the first terminal part is exposed from the insulating layer for forming an electrode, wherein a second portion of the first terminal part is disposed in the body, and an outer surface of the internal metal part of the second portion of the terminal part is exposed from the insulating layer.

### CROSS-REFERENCES TO RELATED APPLICATIONS

This application claims the benefit of U.S. Provisional Patent Application No. 63/297,805, filed on Jan. 10, 2022, which is hereby incorporated by reference herein and made a part of the specification.

### BACKGROUND OF THE INVENTION

### I. Field of the Invention

The present invention relates to a magnetic device, and in particular, to an inductor having a coil disposed in the body of the inductor.

### II. Description of Related Art

Conventional ways to form a type of inductor requires integrating an insulated conductive wire that forms a coil with a body, and then certain undesired portions of the insulated wire encapsulating a terminal part of the insulated conductive wire will be removed after the insulated conductive wire is encapsulated in the body, and then electrodes can be formed on the internal metal of the terminal part on the body. However, by doing so, undesired insulating material between the body and a terminal part of the insulated conductive wire will be seen on the surfaces on which electroplated metal layers will be formed, as a result, gaps will be generated between different portions of the electrode formed on the body. In addition, discontinuities of the metal layers can be generated as well in the electroplated metal layers.

Therefore, a better solution is needed to resolve the above-mentioned issues.

### SUMMARY OF THE INVENTION

One objective of the present invention is to remove unwanted portions of a terminal part of an insulated conductive wire for forming a coil before integrating the insulated conductive wire with a body to form a magnetic device such as an inductor, so that the surfaces on which an electrode can be formed thereon without seeing undesired insulating material between the body and a terminal part of the insulated conductive wire, thereby avoiding the gaps between different portions of the electrode formed on the body as well as the discontinuities of the metal layers that can be electroplated on the body.

One objective of the present invention is to provide an electrode structure based on the dimensions of a terminal part and an electrode formed thereon to reduce DCR loss and increase the strength of the electrode used as an SMD pad.

In one embodiment of the present invention, a magnetic device is disclosed, wherein the magnetic device comprises: a body; and an insulated conductive wire, comprising a metal wire and an insulating layer encapsulating the metal wire, wherein the insulated conductive wire comprises at least one winding turn to form a coil and a first terminal part, wherein the at least one winding turn of the coil is disposed in the body, wherein the first terminal part of the conductive wire comprises a first portion and a second portion with the second portion of the first terminal part being extending from the at least one winding turn of the coil to an endpoint of the first portion of the first terminal part, wherein the first portion of the first terminal part comprises a first portion of the metal wire, wherein an outer surface of the first portion of the metal wire is exposed from the insulating layer for forming a first electrode of the magnetic device, wherein the second portion of the first terminal part comprises a second portion of the metal wire, wherein the second portion of the first terminal part is disposed in the body, and an outer surface of the second portion of the metal wire is exposed from the insulating layer.

In one embodiment, a bottom surface of the first portion of the metal wire and a bottom surface of the body is substantially coplanar with a distance between the outer surface of the first portion of the metal wire and the bottom surface of the body being less than 10 um.

In one embodiment, the second portion of the metal wire being exposed from the insulated conductive wire has a convex curve relative to a vertical line passing through the endpoint of the first portion of the first terminal part.

In one embodiment, the magnetic device is an inductor, wherein the body comprises a magnetic body, wherein the coil is disposed in the magnetic body.

In one embodiment, the first electrode of the magnetic device comprises a first metal layer disposed on the bottom surface of the body and electrically connected to the first terminal part of the conductive wire.

In one embodiment, the first metal layer is formed by electroplating.

In one embodiment, the first electrode further comprises a second metal layer disposed on the first metal layer.

In one embodiment, the conductive wire is an insulated flat wire.

In one embodiment, the conductive wire is an enameled wire.

In one embodiment, the conductive wire is an insulated flat wire, wherein the outer surface of the second portion of the metal wire comprises a bottom surface of the second portion of the metal wire, wherein said bottom surface of the second portion of the metal wire is exposed from the insulating layer.

In one embodiment, the conductive wire is an insulated flat wire, wherein the outer surface of the second portion of the metal wire comprises a bottom surface and a lateral surface of the second portion of the metal wire, wherein the bottom surface and the lateral surface of the second portion of the metal wire are exposed from the insulating layer.

In one embodiment, the conductive wire is an insulated flat wire, wherein the outer surface of the second portion of the metal wire comprises a bottom surface, a first lateral surface, and a second lateral surface of the second portion of the metal wire, wherein said bottom surface and said lateral surfaces the second portion of the metal wire are exposed from the insulating layer.

In one embodiment, a second terminal part of the conductive wire comprises a first portion and a second portion with the second portion of the second terminal part being extending from the at least one winding turn of the coil to an endpoint of the first portion of the second terminal part, wherein the first portion of the second terminal part comprises a third portion of the metal wire, wherein an outer surface of the third portion of the metal wire is exposed from the insulating layer for forming a second electrode of the magnetic device, wherein the second portion of the second terminal part comprises a fourth portion of the metal wire, wherein the second portion of the second terminal part is disposed in the body, and an outer surface of the fourth portion of the metal wire is exposed from the insulating layer.

In one embodiment, the second portion of the second terminal part comprises an outer surface that has a convex curve relative to a vertical line passing through the endpoint of the first portion of the second terminal part.

In one embodiment of the present invention, a method to form a magnetic device is disclosed, wherein the method comprises: providing an insulated conductive wire, wherein the insulated conductive wire comprises a metal wire and an insulating layer encapsulating the metal wire, wherein the insulated conductive wire comprises at least one winding turn to form a coil and a first terminal part, wherein the first terminal part of the conductive wire comprises a first portion and a second portion with the second portion of the first terminal part being extending from the at least one winding turn of the coil to an endpoint of the first portion of the first terminal part, wherein the first portion of the first terminal part comprises a first portion of the metal wire, wherein an outer surface of the first portion of the metal wire is exposed from the insulating layer, wherein the second portion of the first terminal part comprises a second portion of the metal wire, wherein an outer surface of the second portion of the metal wire is exposed from the insulating layer; and integrating the insulated conductive wire with a body, wherein the at least one winding turn of the coil is disposed in the body, wherein said outer surface of the first portion of the metal wire being exposed from the insulating layer is exposed from said body for forming a first electrode of the magnetic device, and the second portion of the first terminal part is disposed in the body with said outer surface of the second portion of the metal wire being exposed from the insulating layer.

In one embodiment, the magnetic device is an inductor, wherein the body comprises a magnetic body, wherein the coil is disposed in the magnetic body.

In one embodiment, the distance between the outer surface of the first portion of the metal wire and the bottom surface of the body is less than 10 um.

In one embodiment of the present invention, a magnetic device is disclosed, wherein the magnetic device comprises: a body; and a conductive wire, wherein the conductive wire comprises at least one winding turn to form a coil and a first terminal part, wherein the at least one winding turn of the coil is disposed in the body, wherein the first terminal part comprises a first portion of a metal wire that is exposed from a bottom surface of the body, wherein the width of the first portion of the metal wire is W and the thickness of the first portion of the metal wire is T, wherein a height from a bottom surface of the coil to a bottom surface of the body is D, and an inner diameter of the coil is r; a first electrode, disposed on the bottom surface of the body and electrically connected to the first terminal part, wherein the width of the first electrode is W and the length of the first electrode is L, wherein

B×T>W×L×5%,

and

r/2≥2×B.

In one embodiment of the present invention, a magnetic device is disclosed, wherein the magnetic device comprises: a body; and a conductive wire, wherein the conductive wire comprises at least one winding turn to form a coil and a first terminal part, wherein the at least one winding turn of the coil is disposed in the body, wherein the first terminal part comprises a first portion of a metal wire that is exposed from a bottom surface of the body, wherein the width of the first portion of the metal wire is W and the thickness of the first portion of the metal wire is T, wherein an inner diameter of the coil is r; a first electrode, disposed on the bottom surface of the body and electrically connected to the first terminal part, wherein the width of the first electrode is W and the length of the first electrode is L, wherein

B×T>W×L×30%, r/2≥2×B,

and

D>1.5T.

In one embodiment of the present invention, a magnetic device is disclosed, wherein the magnetic device comprises: a body; and a conductive wire, wherein the conductive wire comprises at least one winding turn to form a coil and a first terminal part, wherein the at least one winding turn of the coil is disposed in the body, wherein the first terminal part comprises a first portion of a metal wire that is exposed from a bottom surface of the body, wherein the width of the first portion of the metal wire is W and the thickness of the first portion of the metal wire is T, wherein an inner diameter of the coil is r; a first electrode, disposed on the bottom surface of the body and electrically connected to the first terminal part, wherein the width of the first electrode is W and the length of the first electrode is L, wherein

B×T>W×L×50%, r/2≥2×B,

and

D>1.5×T

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1A is a top view illustrating a magnetic device showing a first terminal part according to one embodiment of the present invention;

FIG. 1B depicts a cross-sectional view of the magnetic device obtained by cutting along the line AA′ in FIG. 1A without electrodes;

FIG. 1C depicts a first electrode on the bottom surface of the magnetic device based on FIG. 1B;

FIG. 1D depicts a first electrode on the bottom surface and lateral surfaces of the magnetic device based on FIG. 1B;

FIG. 1E depicts a cross-sectional view of a magnetic device using a method which removes a portion of the insulating layer encapsulating a terminal part of a conductive wire after the conductive wire is integrated with a body;

FIG. 2A is a top view illustrating a magnetic device showing a second terminal part according to one embodiment of the present invention;

FIG. 2B depicts a cross-sectional view of the magnetic device obtained by cutting along the line BB′ in FIG. 2A without electrodes;

FIG. 2C depicts a second electrode on the bottom surface of the magnetic device based on FIG. 2B;

FIG. 2D depicts a second electrode on the bottom surface and lateral surfaces of the magnetic device based on FIG. 2B;

FIG. 3A depicts a top view of a magnetic device according to one embodiment of the present invention;

FIG. 3B depicts a cross-sectional view of the magnetic device obtained by cutting along the line CC′ in FIG. 3A without electrodes;

FIG. 3C depicts an electrode on the bottom surface of the magnetic device;

FIG. 3D depicts a cross-sectional view of a magnetic device using a method which removes a portion of the insulating layer encapsulating a terminal part of a conductive wire after the conductive wire is integrated with a body;

FIG. 4A depicts a top view of a magnetic device according to one embodiment of the present invention;

FIG. 4B depicts a cross-sectional view of the magnetic device obtained by cutting along line DD′ in FIG. 4A without electrodes;

FIG. 4C depicts an electrode on the bottom surface of the magnetic device;

FIG. 4D depicts a cross-sectional view of a magnetic device using a method which removes a portion of the insulating layer encapsulating a terminal part of a conductive wire after the conductive wire is integrated with a body;

FIG. 5A depicts a top view of a magnetic device according to one embodiment of the present invention;

FIG. 5B depicts a top view of the magnetic device with the dimension of an electrode;

FIG. 5C depicts a terminal part for forming the electrode of the magnetic device;

FIG. 6A depicts a top view of a magnetic device according to one embodiment of the present invention;

FIG. 6B depicts a top view of the magnetic device with the dimension of an electrode;

FIG. 6C depicts a terminal part for forming the electrode of the magnetic device;

FIG. 7A depicts a top view of a magnetic device according to one embodiment of the present invention;

FIG. 7B depicts a top view of the magnetic device with the dimension of an electrode;

FIG. 7C depicts a terminal part for forming the electrode of the magnetic device;

FIG. 8A depicts a top view of a magnetic device according to one embodiment of the present invention;

FIG. 8B depicts a cross-sectional view of a magnetic device according to one embodiment of the present invention; and

FIG. 8C compares the performance of ACR rising ratio at different frequencies based on the height of the electrode disposed on the lateral surface of the body;

### DESCRIPTION OF EMBODIMENTS

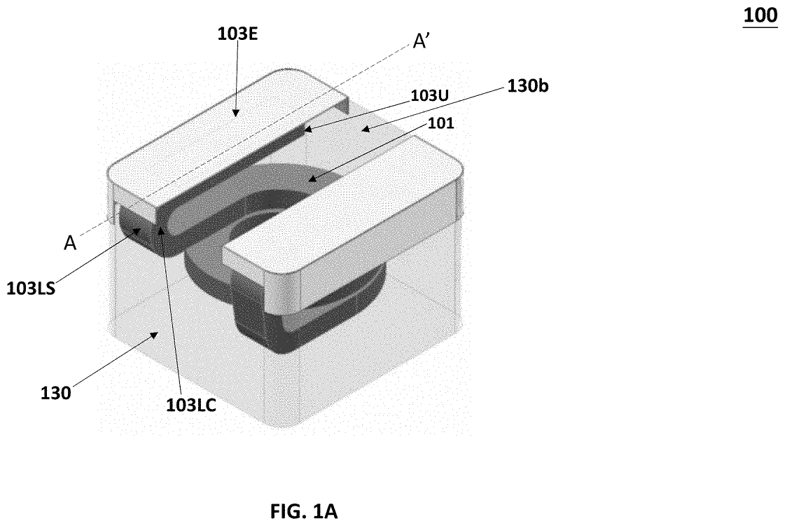

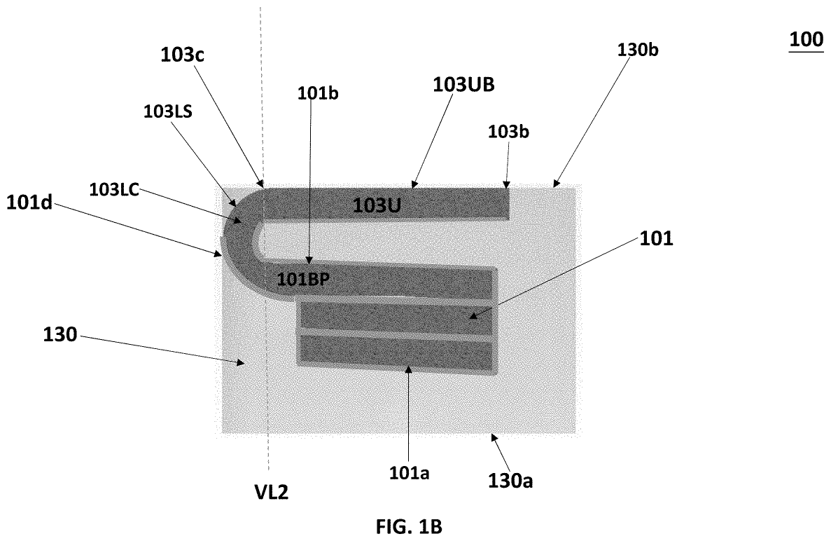

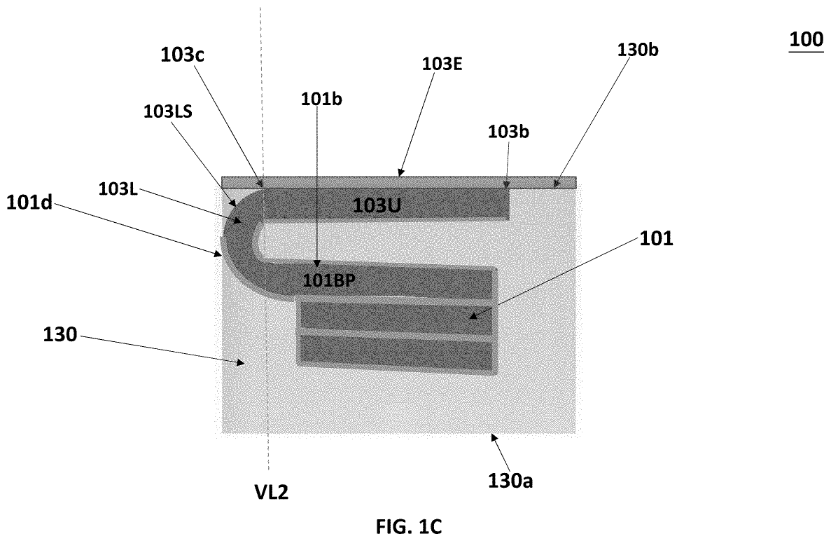

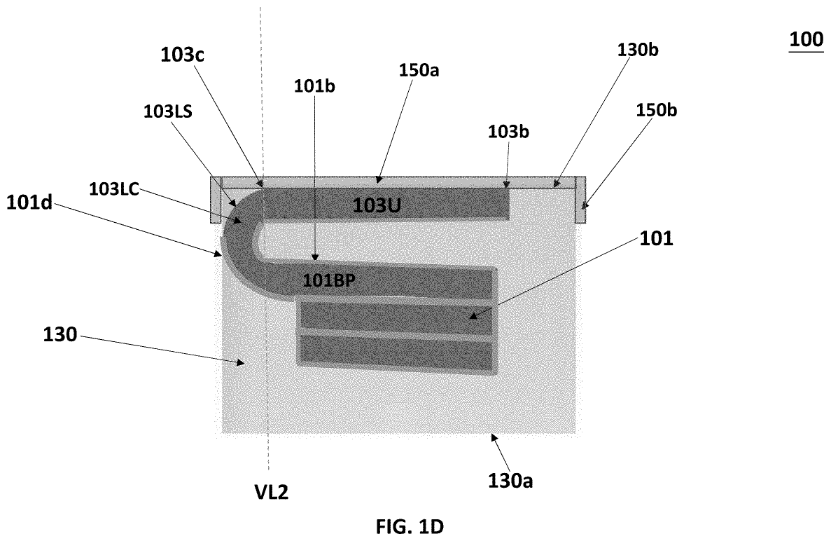

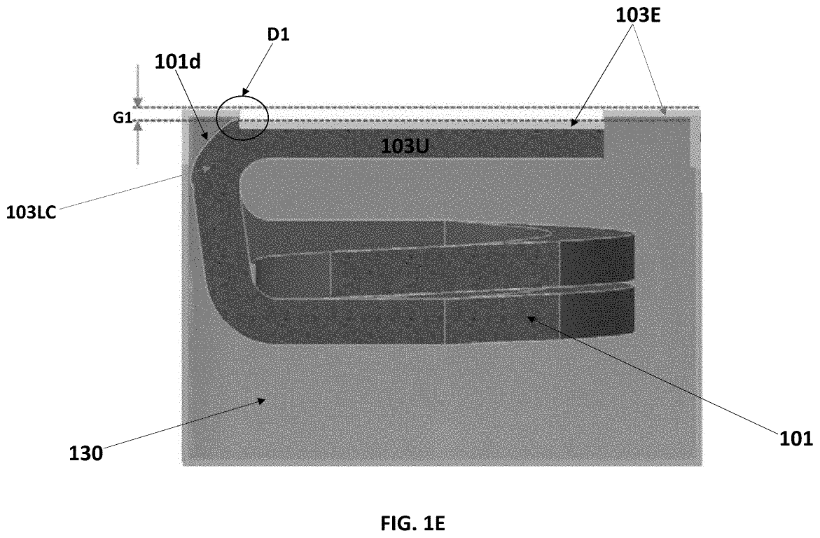

FIG. 1A depicts a top view of a magnetic device 100 according to one embodiment of the present invention; FIG. 1B depicts a cross-sectional view of the magnetic device 100 obtained by cutting along the line AA′ in FIG. 1A without electrodes; FIG. 1C depicts a first electrode of the magnetic device based on FIG. 1B.

Please refer to FIG. 1A, FIG, 1B and FIG. 1C together, wherein the magnetic device 100 comprises a body 130 having a top surface 130a and a bottom surface 130b; and a coil 101 that is formed by an insulated conductive wire which has an metal wire encapsulated by an insulating layer, wherein the coil 101 comprises at least one winding turn made of the metal wire, wherein the at least one winding turn made of the metal wire has a top surface 101a and a bottom surface 101b, wherein the at least one winding turn of the coil 101 is disposed in the body 130, wherein a first terminal part of the insulated conductive wire comprises a first portion 103U having a beginning point 103b and an endpoint 103c and a second portion 103LC, wherein at least one portion of the first portion 103U is exposed from the body 130 for forming an electrode 103E of the magnetic device 100, and the second portion 103LC the second portion 103LC of the first terminal part extends from the at least one winding turn of the coil 101 to an endpoint 103c of the first portion 103U of the first terminal part, wherein the first portion 103U of the first terminal part comprises a first portion of the metal wire, wherein an outer surface of the first portion of the metal wire is exposed from the insulating layer 101d of the insulated conductive wire for forming a first electrode 103E of the magnetic device 100, wherein the second portion 103LC of the first terminal part comprises a second portion of the metal wire, wherein the second portion 103LC of the first terminal part is disposed in the body, and an outer surface 103LS of the second portion of the metal wire is exposed from the insulating layer.

In one embodiment, as shown in FIG. 1B, the outer surface 103LS of the second portion of the metal wire is in contact with body 130.

In one embodiment, as shown in FIG. 1B, wherein the first portion 103U of the first terminal part has a beginning point 103b and an endpoint 103c, and the second portion 103LC extends from a bottom portion 101BP of the coil 101 to the endpoint 103c of the first portion 103U of the first terminal part of the insulated conductive wire, and the outer surface 103LS of the second portion of the metal wire being exposed from the insulating layer 101d comprises a portion that is located between a top surface of the first portion 103U of the first terminal part and the bottom portion 101BP. of the coil 101, wherein the bottom surface of the first portion 103U is exposed from the body 130 for forming the electrode 103E.

In one embodiment, as shown in FIG. 1B, wherein the first portion 103U of the first terminal part has a beginning point 103b and an endpoint 103c, and the second portion 103LC extends from a bottom portion 101BP of the coil 101 to the endpoint 103c of the first portion 103U of the first terminal part of the insulating conductive wire, wherein the second portion 103LC of the first terminal part comprises an outer surface that has a convex curve 103LS relative to a vertical line VL2 passing through the endpoint 103c of the first portion 103U of the second terminal part of the insulating conductive wire.

In one embodiment, body 130 comprises a magnetic body, wherein coil 101 is disposed in the magnetic body.

In one embodiment, the magnetic device 100 is an inductor.

In one embodiment, body 130 comprises a magnetic body, wherein coil 101 is disposed in the magnetic body.

In one embodiment, the first metal layer is formed by electroplating.

In one embodiment, the first electrode 103E further comprises a second metal layer disposed on the first metal layer.

In one embodiment, the insulating conductive wire forming coil 101 is an insulated flat wire.

In one embodiment, the insulating conductive wire forming coil 101 is an insulated flat wire, and the bottom surface 103UB of the second portion of the metal wire is exposed from the insulating layer.

In one embodiment, the insulating conductive wire forming coil 101 is an insulated round wire.

In one embodiment, the insulating conductive wire forming coil 101 is an enameled wire.

In one embodiment, the insulating conductive wire forming coil 101 is an enameled flat wire.

In one embodiment, the conductive wire forming the coil 101 is an enameled round wire.

In one embodiment, as shown in FIG. 1B, a bottom surface 103UB of the first portion of the metal wire and a bottom surface 130b of the body 130 is substantially coplanar with a distance between the bottom surface 103UB of the first portion of the metal wire and the bottom surface 130b of the body 130 being less than 10 um.

In one embodiment, as shown in FIG. 1C, the first electrode 103E of the magnetic device 100 comprises at least one metal layer disposed on the bottom surface of the body and electrically connected to the first terminal part of the conductive wire.

In one embodiment, as shown in FIG. 1D, wherein the electrode 103E comprises at least one metal layer 150a disposed on the bottom surface 130b of the body 130 and electrically connected to the first portion 103U of the first terminal part of the insulating conductive wire, wherein at least one second metal layer 150b is disposed on a lateral surface of the body 130 and electrically connected to the at least one first metal layer 150a.

FIG. 1E shows an electrode of a type of inductor that requires integrating an insulated conductive wire that forms a coil with a body, and then certain undesired portions of the insulated wire encapsulating a terminal part of the insulated conductive wire will be removed after the insulated conductive wire is encapsulated in the body, and then electrodes can be formed on the internal metal of the terminal part on the body. However, by doing so, as shown in FIG. 1E, undesired insulating material between the body and a terminal part of the insulated conductive wire will be seen in a region D1 on the surfaces on which electroplated metal layers will be formed, and a gap G1 with a height greater than 10 um will be generated between different portions of the electrode formed on the body. In addition, discontinuities of the metal layers can be generated as well in the electroplated metal layers in region D1.

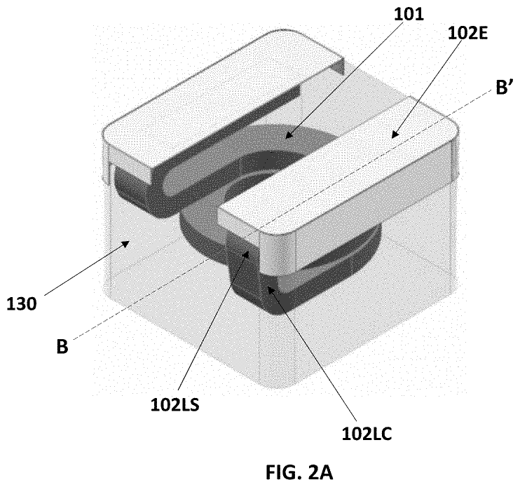

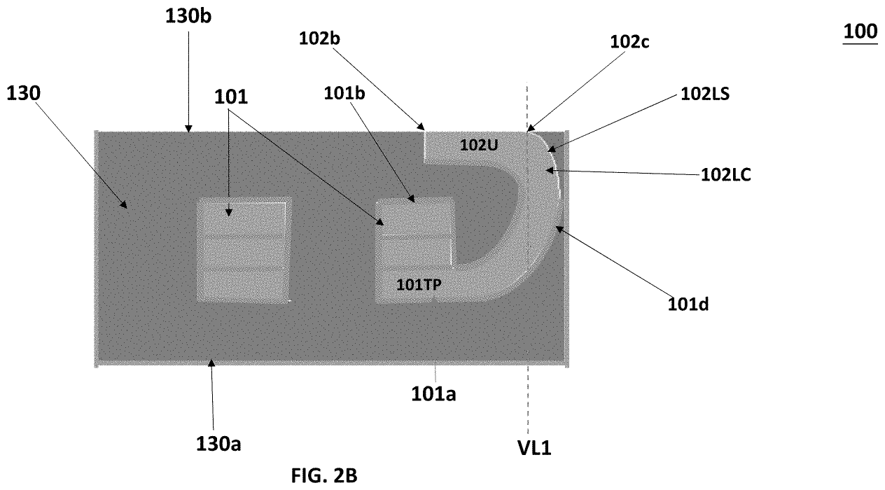

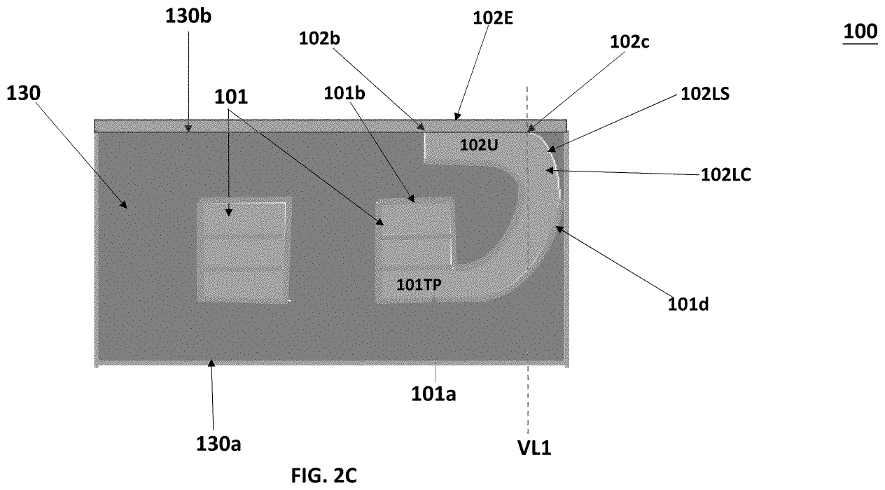

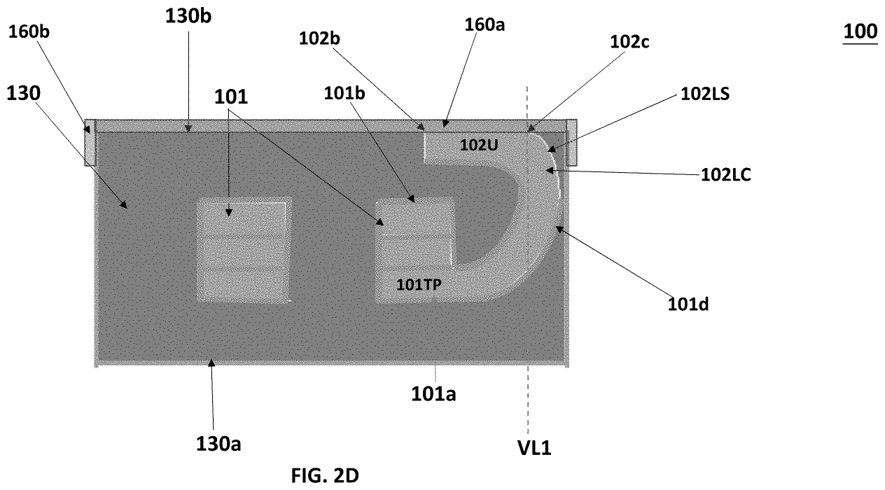

FIG. 2A depicts a top view of a magnetic device 100 according to one embodiment of the present invention; FIG. 2B depicts a cross-sectional view of the magnetic device 100 obtained by cutting along the line BB′ in FIG. 2A without electrodes; FIG. 2C depicts a second electrode of the magnetic device. Please refer to FIG. 2A, FIG, 2B and FIG. 2C together, wherein the magnetic device 100 comprises a body 130 having a top surface 130a and a bottom surface 130b; and a coil 101 that is formed by an insulating conductive wire and disposed in the body 130, wherein the coil 101 comprises at least one winding turn having a top surface 101a and a bottom surface 101b, wherein a second terminal part of the conductive wire comprises a first portion 102U having a beginning point 102b and an endpoint 102c and a second portion 102LC, wherein at least one portion of the first portion 102U is exposed from the body 130 for forming an electrode 102E of the magnetic device 100, and the second portion 102LC the second portion 102LC of the second terminal part being extends from the at least one winding turn of the coil 101 to an endpoint 102c of the first portion 102U of the first terminal part, wherein the first portion 102U of the second terminal part comprises a third portion 102U of the metal wire, wherein an outer surface of the third portion 102U of the metal wire is exposed from the insulating layer 101d for forming a first electrode 102E of the magnetic device 100, wherein the second portion 102LC of the first terminal part comprises a fourth portion of the metal wire, wherein the second portion 103LC of the first terminal part is disposed in the body, and an outer surface 102LS of the fourth portion of the metal wire is exposed from the insulating layer.

In one embodiment, as shown in FIG. 2B, the first portion 102U of the second terminal part of the conductive wire has a beginning point 102b and an endpoint 102c, and the second portion 102LC extends from a top portion 101TP of the coil 101 to the endpoint 102c of the first portion 102U of the second terminal part of the conductive wire, wherein the second portion 102LC comprises an outer surface that has a convex curve 102LS relative to a vertical line VL1 passing through the endpoint 102c of the first portion 102U of the second terminal part of the conductive wire.

In one embodiment, as shown in FIG. 2C, the first electrode 102E of the magnetic device 100 comprises at least one metal layer disposed on the bottom surface of the body and electrically connected to the first portion 102U of the second terminal part of the conductive wire.

In one embodiment, as shown in FIG. 2D, wherein the electrode 102E comprises at least one metal layer 160a disposed on the bottom surface 130b of the body 130 and electrically connected to the first portion 102U of the first terminal part of the conductive wire, wherein at least one second metal layer 160b is disposed on a lateral surface of the body 130 and electrically connected to the at least one first metal layer 160a.

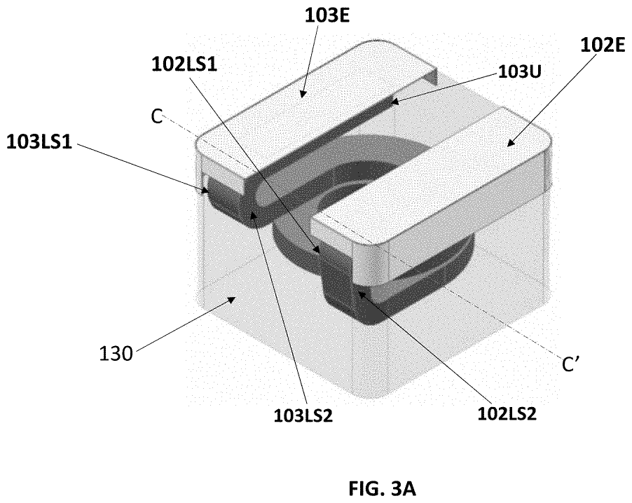

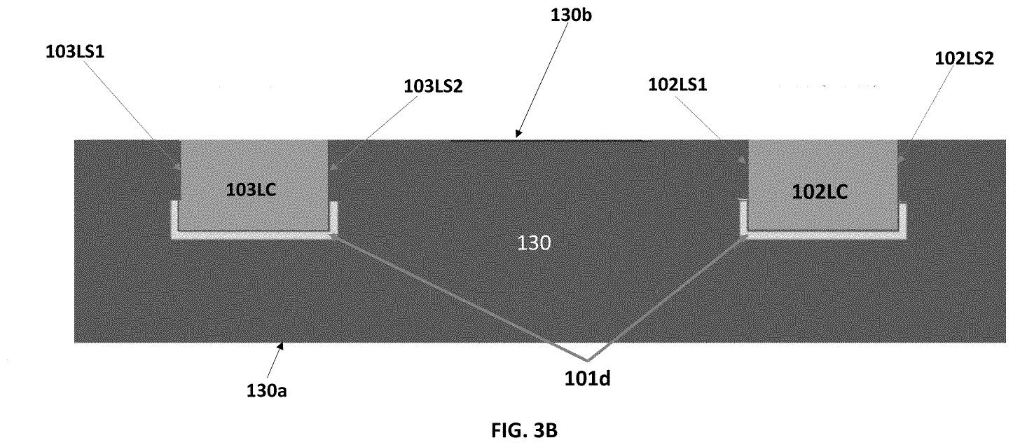

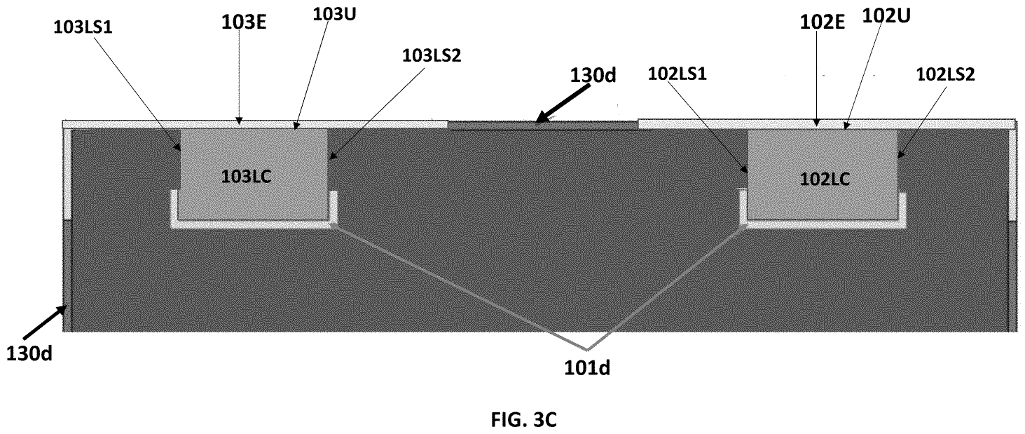

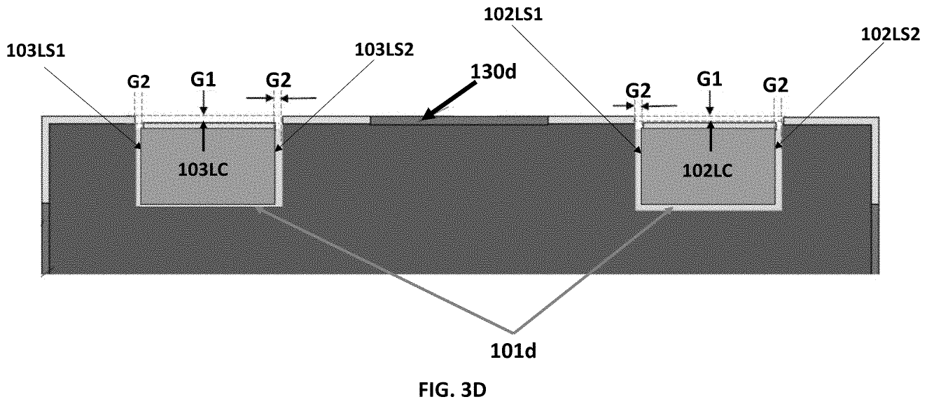

FIG. 3A depicts a top view of a magnetic device 100 according to one embodiment of the present invention; FIG. 3B depicts a cross-sectional view of the magnetic device 100 obtained by cutting along the line CC′ in FIG. 3A without electrodes; FIG. 3C depicts an electrode of the magnetic device.

Please refer to FIG. 3A, FIG. 3B, and FIG. 3C together. In one embodiment, a first lateral surface 103LS1 or a second lateral surface 103LS2 of the second portion 103LC of the first terminal part is exposed from the insulating layer 101d. In one embodiment, a first lateral surface 103LS1 and a second lateral surface 103LS2 of the second portion 103LC of the first terminal part are exposed from the insulating layer 101d. In one embodiment, a first lateral surface 102LS1 or a second lateral surface of the 102LS2 of the second portion 102LC of the second terminal part is exposed from the insulating layer 101d. In one embodiment, a first lateral surface 102LS1 and a second lateral surface 102LS2 of the second portion 102LC of the second terminal part are exposed from the insulating layer 101d. As shown in FIG. 3C, electrode 103E is disposed on the magnetic body and electrically connected to the second portion 103LC of the first terminal part, and electrode 102E is disposed on the magnetic body and electrically connected to the second portion 102LC of the first terminal par. As shown in FIG. 3C, an insulating layer 130d is formed on the body 130 between the electrodes 103E, 102E. In one embodiment, each of the first lateral surface 103LS1 and the second lateral surface 103LS2 of the second portion 103LC of the first terminal part can be in contact with the body 130. In one embodiment, each of the first lateral surface 102LS1 and the second lateral surface 102LS2 of the second portion 103LC of the first terminal part can be in contact with the body 130.

FIG. 3D shows an electrode of a type of inductor that requires integrating an insulated conductive wire that forms a coil with a body, and then certain undesired portions of the insulated wire encapsulating a terminal part of the insulated conductive wire will be removed after the insulated conductive wire is encapsulated in the body, and then electrodes can be formed on the internal metal of the terminal part on the body. However, by doing so, as shown in FIG. 3D, undesired insulating material between the body and a terminal part of the insulated conductive wire will be seen in regions on the surfaces on which electroplated metal layers will be formed, and gaps G1, G2 will be generated between different portions of the electrode formed on the body, wherein the height of the gap G1 is greater than 10 um. In addition, discontinuities of the metal layers can be generated as well in the electroplated metal layers due to the gaps G1, G2.

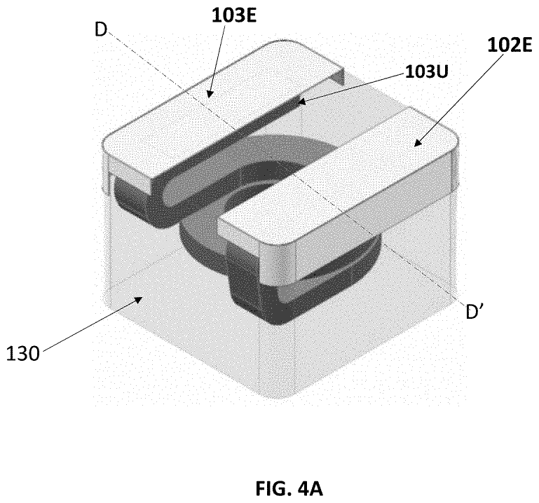

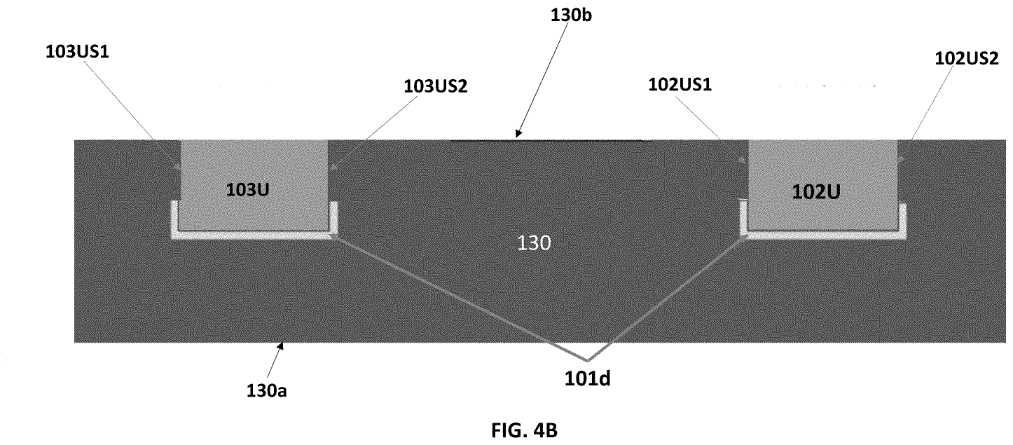

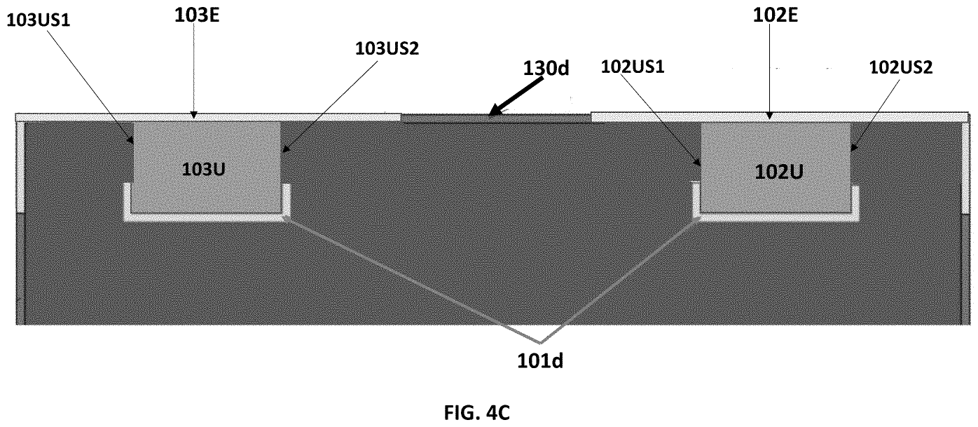

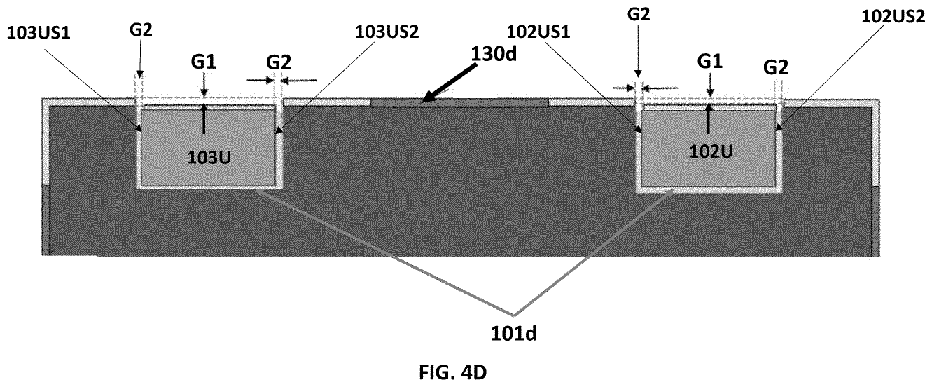

FIG. 4A depicts a top view of a magnetic device 100 according to one embodiment of the present invention; FIG. 4B depicts a cross-sectional view of the magnetic device 100 obtained by cutting along the line DD′ in FIG. 4A without electrodes; FIG. 4C depicts an electrode of the magnetic device.

Please refer to FIG. 4A, FIG. 4B, and FIG. 4C together. In one embodiment, a first lateral surface 103US1 or a second lateral surface 103US2 of the first portion 103U of the first terminal part is exposed from the insulating layer 101d. In one embodiment, a first lateral surface 103US1 and a second lateral surface 103US2 of the first portion 103U of the first terminal part are exposed from the insulating layer 101d. In one embodiment, a first lateral surface 102US1 or a second lateral surface of the 102US2 of the first portion 102U of the second terminal part is exposed from the insulating layer 101d. In one embodiment, a first lateral surface 102US1 and a second lateral surface 102US2 of the first portion 102U of the second terminal part are exposed from the insulating layer 101d. As shown in FIG. 4C, electrode 103E is disposed on the magnetic body and electrically connected to the first portion 103U of the first terminal part, and electrode 102E is disposed on the magnetic body and electrically connected to the first portion 102U of the second terminal part. As shown in FIG. 4C, an insulating layer 130d is formed on the body 130 between the electrodes 103E, 102E. In one embodiment, each of the first lateral surface 103US1 and the second lateral surface 103US2 of the first portion 103U of the first terminal part can be in contact with the body 130. In one embodiment, each of the first lateral surface 102US1 and the second lateral surface 102US2 of the second portion 10U of the first portion 102U of the second terminal part can be in contact with the body 130.

FIG. 4D shows an electrode of a type of inductor that requires integrating an insulated conductive wire that forms a coil with a body, and then certain undesired portions of the insulated wire encapsulating a terminal part of the insulated conductive wire will be removed after the insulated conductive wire is encapsulated in the body, and then electrodes can be formed on the internal metal of the terminal part on the body. However, by doing so, as shown in FIG. 4D, undesired insulating material between the body and a terminal part of the insulated conductive wire will be seen in regions on the surfaces on which electroplated metal layers will be formed, as a result, gaps G1, G2 will be generated between different portions of the electrode formed on the body. In addition, discontinuities of the metal layers can be generated as well in the electroplated metal layers due to the gaps G1, G2, wherein the height of the gap G1 is greater than 10 um.

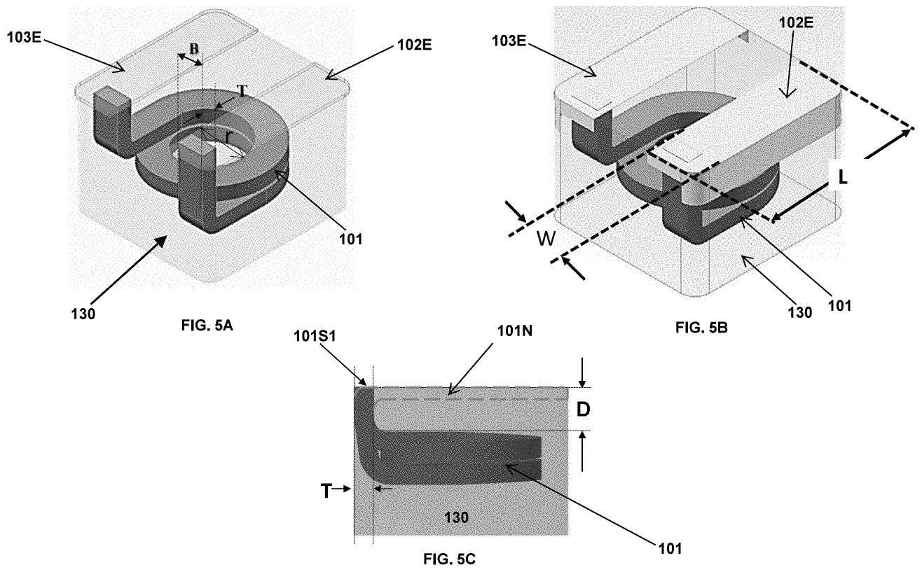

FIG. 5A depicts a top view of a magnetic device according to one embodiment of the present invention; FIG. 5B depicts a top view of the magnetic device with the dimension of an electrode; FIG. 5C depicts a terminal part for forming the electrode of the magnetic device. Please refer to FIG. 5A, FIG. 5B, and FIG. 5C together, wherein a magnetic device comprises a body 130; and a conductive wire, wherein the conductive wire comprises at least one winding turn to form a coil 101 and a first terminal part 101S1, wherein the at least one winding turn of the coil 101 is disposed in the body 130, wherein the first terminal part 101S1 comprises a first portion of a metal wire that is exposed from a bottom surface of the body 130, wherein the width of the first portion of the metal wire is W and the thickness of the first portion of the metal wire is T, wherein an inner diameter of the coil is r; a first electrode 102E, disposed on the bottom surface of the body 130 and electrically connected to the first terminal part 101S1, wherein the width of the first electrode 102E is W and the length of the first electrode is L, wherein B×T>W×L×5%, and r/2≥2×B. In one embodiment, B×T>W×L×5%, B×T<W×L×40%, and r/2≥2×B.

As shown in FIG. 5C, in one embodiment, the axial surface of the first terminal part 101S1 is exposed from body 130 so that it can save the space 101N by allowing more magnetic material to be filled inside the body to reduce the DCR loss. In addition, the saturation current can be adjusted by the height D from the bottom surface of the coil to the bottom surface of the magnetic body.

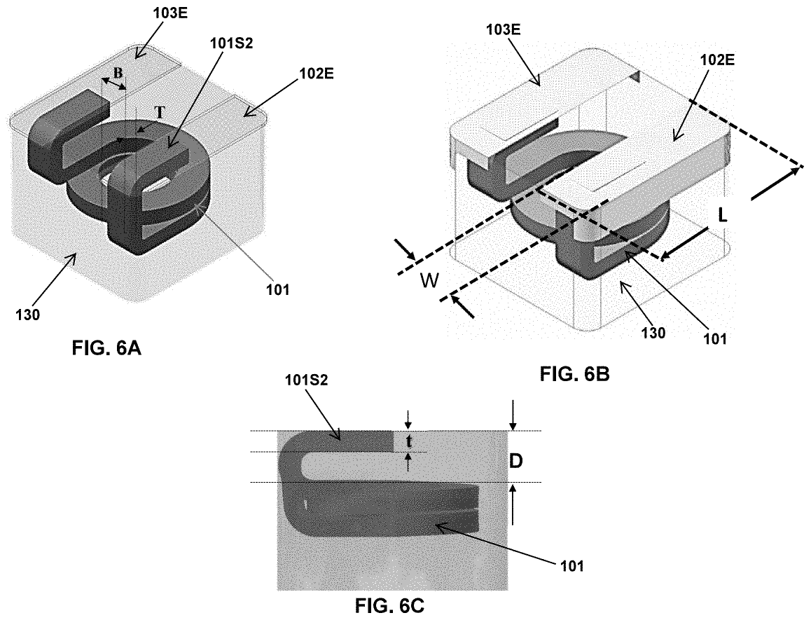

FIG. 6A depicts a top view of a magnetic device according to one embodiment of the present invention; FIG. 6B depicts a top view of the magnetic device with the dimension of an electrode; FIG. 6C depicts a terminal part for forming the electrode of the magnetic device. Please refer to FIG. 6A, FIG. 6B, and FIG. 6C together, wherein a magnetic device comprises a body 130; and a conductive wire, wherein the conductive wire comprises at least one winding turn to form a coil 101 and a first terminal part 101S2, wherein the at least one winding turn of the coil 101 is disposed in the body, wherein the first terminal part 101S2 comprises a first portion of a metal wire that is exposed from a bottom surface of the body 130, wherein the width of the first portion of the metal wire is W and the thickness of the first portion of the metal wire is T, wherein an inner diameter of the coil is r; a first electrode 102E, disposed on the bottom surface of the body 130 and electrically connected to the first terminal part 101S2, wherein the width of the first electrode 102E is W and the length of the first electrode is L, and the height from the bottom surface of the coil to the bottom surface of the body is D, wherein B×T>W×L×30%, and r/2≥2×B, and D>1.5×T. In one embodiment, B×T>W×L×30%, B×T<W×L×60%, and r/2≥2×B. By doing so, it can increase the strength of the electrode used as a SMD pad, and the heat dissipation capability can be increased as well.

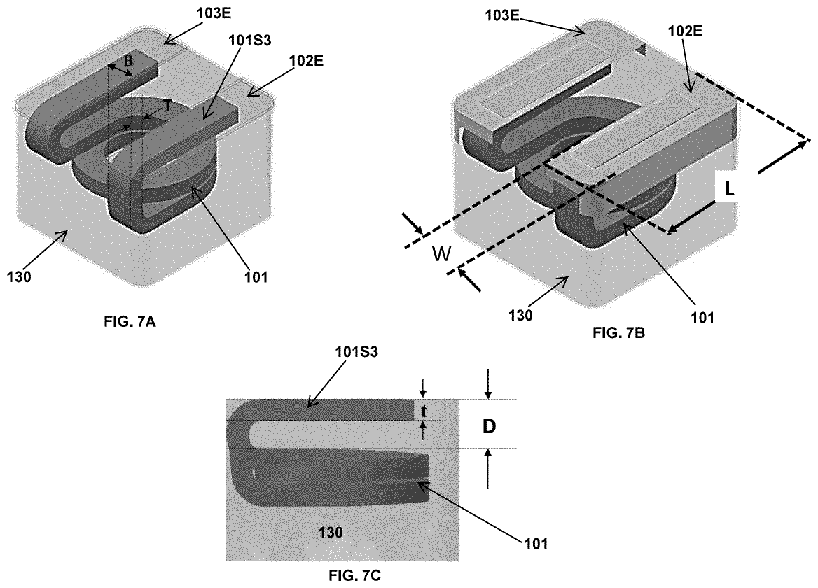

FIG. 7A depicts a top view of a magnetic device according to one embodiment of the present invention; FIG. 7B depicts a top view of the magnetic device with the dimension of an electrode; FIG. 7C depicts a terminal part for forming the electrode of the magnetic device. Please refer to FIG. 7A, FIG. 7B, and FIG. 7C together, wherein a magnetic device comprises a body 130; and a conductive wire, wherein the conductive wire comprises at least one winding turn to form a coil 101 and a first terminal part 101S3, wherein the at least one winding turn of the coil 101 is disposed in the body, wherein the first terminal part 101S3 comprises a first portion of a metal wire that is exposed from a bottom surface of the body 130, wherein the width of the first portion of the metal wire is W and the thickness of the first portion of the metal wire is T, wherein an inner diameter of the coil is r; a first electrode 102E, disposed on the bottom surface of the body 130 and electrically connected to the first terminal part 101S3, wherein the width of the first electrode 102E is W and the length of the first electrode is L, and the height from the bottom surface of the coil to the bottom surface of the body is D wherein B×T>W×L×50%, and r/2≥2×B. and D>1.5×T. By doing so, it can increase the strength of the electrode used as a SMD pad, and the heat dissipation capability can be increased as well.

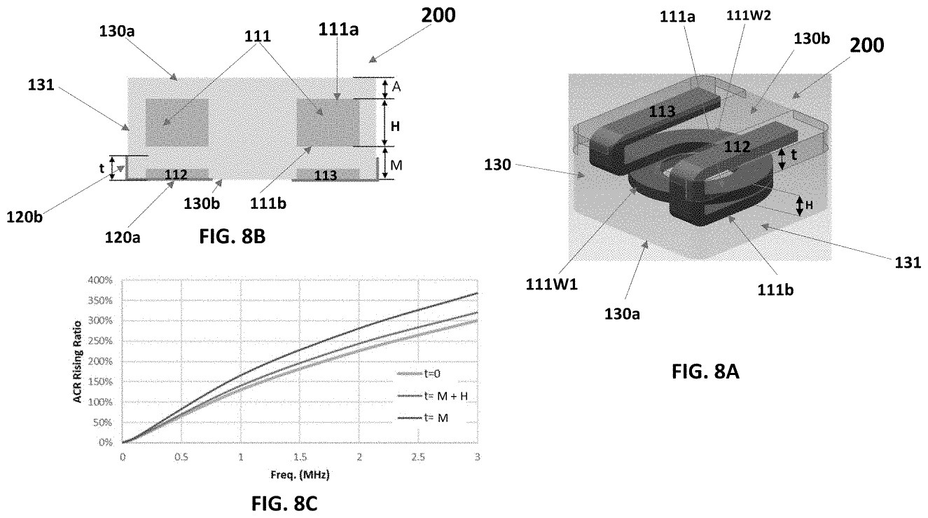

FIG. 8A depicts a top view of a magnetic device and FIG. 8B depicts a cross-sectional view of a magnetic device, according to one embodiment of the present invention. Please refer to FIG. 8A and FIG. 8B, wherein the magnetic device 200 comprises a body 130 having a top surface 130a and a bottom surface 130b; and a coil 111 that is formed by a conductive wire and has at least one winding turn 111W1, 111W2 wherein the plurality of winding turns 111W1, 111W are disposed in the body 130 and has a top surface 111a and a bottom surface 111b, wherein at least one portion of a first terminal part 112 of the conductive wire is exposed from the body 130, wherein a first electrode of the magnetic device 200 comprises at least one first metal layer 120a that is disposed on the bottom surface 130b of the body 130 and electrically connected to the first terminal part 112 of the conductive wire and at least one second metal layer 120b that is disposed on a lateral surface 131 of the body 130 and electrically connected to the at least one first metal layer 120a, wherein a first height t of the first electrode disposed on the lateral surface 131 of the body 130 is greater than zero and not greater than a second height H from the top surface 111a to the bottom surface 111b of the plurality of winding turns 111W1, 111W2 of the coil 111.

In one embodiment, the conductive wire forming the plurality of winding turns is an insulated conductive wire.

In one embodiment, the conductive wire forming the plurality of winding turns is an enameled conductive wire.

In one embodiment, the conductive wire forming the plurality of winding turns is an enameled copper wire.

In one embodiment, the conductive wire is a flat wire.

In one embodiment, the conductive wire is a round wire.

In one embodiment, wherein a second electrode of the magnetic device 200 comprises at least one third metal layer that is disposed on a bottom surface 130b of the body 130 and electrically connected to the second terminal part 113 of the conductive wire and at least one fourth metal layer that is disposed on a lateral surface of the body 130 and electrically connected to the at least one third metal layer, wherein a third height of the second electrode disposed on the lateral surface of the body 130 is greater than zero and not greater than the second height H from the top surface 111a to the bottom surface 111b of the plurality of winding turns of the coil 111.

In one embodiment, the present invention can increase the SMD (Surface-mounted Device) soldering strength of the electrode of the magnetic device.

FIG. 8C compares the performance of the ACR rising ratio at different frequencies based on the first height t of the electrode disposed on the lateral surface 131 of body 130, wherein the ACR rising ratio is increasing when the first height t is increasing. As shown in FIG. 8C, the ACR rising ratio is low when the first height t is zero, and the ACR rising ratio is high when the first height t is equal to M plus the second height H between the top surface 111a and the bottom surface 111b of the plurality of winding turns 111W1, 111W2 of the coil 111, wherein M represents the vertical distance between the electrode on the lateral surface 131 of the body 130 and the bottom surface 111b of the plurality of winding turns 111W1, 111W2 of the coil 111.

The first height t of the electrode disposed on the lateral surface 131 of the body 130 is greater than zero and not greater than a second height H from the top surface 111a to the bottom surface 111b of the plurality of winding turns 111W1, 111W2 of the coil 111, which can maintain a good range of the ACR rising ratio of the magnetic device while increasing the SMD (Surface-mounted Device) soldering strength of the electrode of the magnetic device.

In one embodiment, as shown in FIG. 8B, the electrode disposed on the lateral surface 131 of body 130 does not extend across the bottom surface 111b of the plurality of winding turns of the coil.

Although the present invention has been described with reference to the above embodiments, it will be apparent to one of ordinary skill in the art that modifications to the described embodiment may be made without departing from the spirit of the invention. Accordingly, the scope of the invention will be defined by the attached claims, not by the above-detailed descriptions.

What is claimed is:

1. A magnetic device, comprising:
a body; and
an insulated conductive wire, comprising a metal wire and an insulating layer encapsulating the metal wire, wherein the insulated conductive wire comprises a first terminal part and at least one winding turn to form a coil, wherein the at least one winding turn of the coil is disposed in the body, wherein the first terminal part of the insulated conductive wire comprises a first portion and a second portion with the second portion of the first terminal part being extending from the at least one winding turn of the coil to an endpoint of the first portion of the first terminal part, wherein the first portion of the first terminal part comprises a first portion of the metal wire, wherein an outer surface of the first portion of the metal wire is exposed from the insulating layer and the body for forming a first electrode, wherein the second portion of the first terminal part comprises a second portion of the metal wire, wherein the second portion of the first terminal part is disposed in the body, and an outer surface of the second portion of the metal wire is exposed from the insulating layer.

2. The magnetic device according to claim 1, wherein a bottom surface of the first portion of the metal wire and a bottom surface of the body are substantially coplanar with a distance between the outer surface of the first portion of the metal wire and the bottom surface of the body being less than 10 um.

3. The magnetic device according to claim 1, wherein the second portion of the metal wire being exposed from the insulated conductive wire has a convex curve relative to a vertical line passing through the endpoint of the first portion of the first terminal part.

4. The magnetic device according to claim 1, wherein the magnetic device is an inductor, wherein the body comprises a magnetic body, wherein the coil is disposed in the magnetic body.

5. The magnetic device according to claim 1, wherein the first electrode of the magnetic device comprises a first metal layer disposed on a bottom surface of the body and electrically connected to the first terminal part of the conductive wire

6. The magnetic device according to claim 5, wherein the first metal layer is formed by electroplating.

7. The magnetic device according to claim 1, wherein the outer surface of the second portion of the metal wire is in contact with the body.

8. The magnetic device according to claim 1, wherein the insulated conductive wire is a flat wire.

9. The magnetic device according to claim 1, wherein the conductive wire is a round wire.

10. The magnetic device according to claim 8, wherein the outer surface of the second portion of the metal wire comprises a bottom surface of the second portion of the metal wire extending from the bottom surface of the first portion of the metal wire, wherein said bottom surface of the second portion of the metal wire is exposed from the insulating layer.

11. The magnetic device according to claim 8, wherein the outer surface of the second portion of the metal wire comprises a bottom surface and a lateral surface of the second portion of the metal wire, wherein said bottom surface and said lateral surface of the second portion of the metal wire are exposed from the insulating layer.

12. The magnetic device according to claim 8, wherein the outer surface of the second portion of the metal wire comprises a first lateral surface and a second lateral surface of the second portion of the metal wire, wherein the first lateral surface and the second lateral surface of the second portion of the metal wire are exposed from the insulating layer.

13. The magnetic device according to claim 1, wherein a second terminal part of the conductive wire comprises a first portion and a second portion with the second portion of the second terminal part being extending from the at least one winding turn of the coil to an endpoint of the first portion of the second terminal part, wherein the first portion of the second terminal part comprises a third portion of the metal wire, wherein an outer surface of the third portion of the metal wire is exposed from the insulating layer for forming a second electrode of the magnetic device, wherein the second portion of the second terminal part comprises a fourth portion of the metal wire, wherein the second portion of the second terminal part is disposed in the body, and an outer surface of the fourth portion of the metal wire is exposed from the insulating layer.

14. The magnetic device according to claim 13, wherein the second portion of the second terminal part comprises an outer surface that has a convex curve relative to a vertical line passing through the endpoint of the first portion of the second terminal part.

15. A method to form a magnetic device, said method comprising:
providing an insulated conductive wire, wherein the insulated conductive wire comprises a metal wire and an insulating layer encapsulating the metal wire, wherein the insulated conductive wire comprises at least one winding turn to form a coil and a first terminal part, wherein the first terminal part of the conductive wire comprises a first portion and a second portion with the second portion of the first terminal part being extending from the at least one winding turn of the coil to an endpoint of the first portion of the first terminal part, wherein the first portion of the first terminal part comprises a first portion of the metal wire, wherein an outer surface of the first portion of the metal wire is exposed from the insulating layer, wherein the second portion of the first terminal part comprises a second portion of the metal wire, wherein an outer surface of the second portion of the metal wire is exposed from the insulating layer; and
integrating the insulated conductive wire with a body for forming a magnetic device, wherein the at least one winding turn of the coil is disposed in the body, wherein said outer surface of the first portion of the metal wire being exposed from the insulating layer is exposed from said body for forming a first electrode of the magnetic device, and the second portion of the first terminal part is disposed in the body with said outer surface of the second portion of the metal wire being exposed from the insulating layer.

16. The method according to claim 15, wherein the magnetic device is an inductor, wherein the body comprises a magnetic body, wherein a coil is disposed in the magnetic body.

17. The method according to claim 15, wherein a distance between the outer surface of the first portion of the metal wire and a bottom surface of the body is less than 10 um.

18. A magnetic device, comprising:
a body; and
a conductive wire, wherein the conductive wire comprises a coil and a first terminal part, wherein the coil is disposed in the body, wherein the first terminal part comprises a first portion of a metal wire that is exposed from a bottom surface of the body, wherein the width of the first portion of the metal wire is W and the thickness of the first portion of the metal wire is T, wherein a height from a bottom surface of the coil to a bottom surface of the body is D, and an inner diameter of the coil made of metal is r;
a first electrode, disposed on the bottom surface of the body and electrically connected to the first terminal part, wherein the width of the first electrode is W and the length of the first electrode is L, wherein B×T>W×L×5%, and r/2≥2×B.

19. The magnetic device according to claim 18, wherein
B×T>W×L×30%, r/2≥2×B,
and
D>1.5×T.

20. The magnetic device according to claim 18, wherein
B×T>W×L×50%, r/2≥2×B,
and
D>1.5×T.
